(19) United States
(12) Patent Application Publication
(10) Pub. No.: US 2025/0129945 A1
(43) Pub. Date: Apr. 24, 2025

(54) HOME APPLIANCE

(71) Applicant: LG Electronics Inc., Seoul (KR)

(72) Inventors: Jaebong JANG, Seoul (KR); Jinseok CHOI, Seoul (KR)

(21) Appl. No.: 18/925,807

(22) Filed: Oct. 24, 2024

(30) Foreign Application Priority Data
Oct. 24, 2023 (KR) 10-2023-0142875

(51) Int. Cl. F25D 23/02

(52) U.S. Cl. CPC F24C 15/02

(57) ABSTRACT

An appliance includes a casing having a storage space, a door, a first electronic component disposed outside the casing, a second electronic component disposed at the door, a wire, and a wire guide. The door is disposed at a front of the storage space and configured to open and close at least a portion of the storage space. The wire is configured to electrically connect the first electronic component to the second electronic component. The wire guide is disposed between the casing and the wire and configured to block physical contact between a surface of the casing and the wire.

### CROSS REFERENCE TO RELATED APPLICATION

The present application claims priority to and the benefit of Korean Patent Application No. 10-2023-0142875, filed on Oct. 24, 2023, the disclosure of which is incorporated herein by reference in its entirety.

### TECHNICAL FIELD

The present disclosure relates to a home appliance.

### BACKGROUND

Home appliances, such as cooking appliances, refrigerators, and garment care devices, may have doors that provide access to storage spaces for storing items. These appliances may include a casing exterior with an interior compartment for storing objects, along with a door for opening and closing the compartment.

In some cases, electronic components may be installed on a door of a home appliance. For example, a touch sensor device, a display device, a lighting device, communication device, etc. may be installed on the door. These electronic components may operate by receiving power supplied from a main body of the home appliance.

The electronic components may be electrically connected, via a wire, to a main control portion located in the body of the home appliance. The wire may be arranged inside the main body of the home appliance to connect the electronic components of the door to the main control portion. Both ends of the wire disposed inside the main body may be connected to the electronic components of the door and the main control part, respectively.

However, the wire provided in an electric home appliance with a very high internal temperature, such as a cooking appliance equipped with a heating device, may be exposed to temperatures that are greater than an allowable threshold temperature. In particular, the wire disposed inside the main body of the home appliance may be in close proximity to the heating device, which may increase the risk of the wire overheating and being damaged more easily. In such cases, wires used to connect communication devices or imaging devices may be more vulnerable to high-temperature environments, because applying high heat-resistant coatings can be difficult due to the nature of the product.

In addition, if the wire is disposed inside the main body of the home appliance, there may be issues with poor workability regarding separating/assembling of the wire. For example, for maintenance purposes, when the wire needs to be separated or assembled, a worker may have to access an interior of the narrow body, which may reduce workability.

In some examples, the wire may be disposed along the outer edge of the casing. For example, the wire may be provided along the casing surface of the home appliance. In such cases, the temperature of the wire may be relatively lower compared to when the wire is disposed inside the main body of the home appliance, but since the casing of the home appliance is also made of metal, heat from the heating device may be transmitted to the wire.

Additionally, the wire may be arranged around the outer edge of the casing so as not to be adjacent to the casing of the home appliance main body. For example, the wire may extend from a lower portion of the door along the bottom of the home appliance to the rear of the home appliance. The wire extending to the rear of the home appliance may extend upward along the rear of the home appliance and may be connected to the main control part.

However, if the wire is arranged around the outer edge of the home appliance like this, not only may the length of the wire increase, leading to increased manufacturing costs, but there may also be an issue of increased noise in the signal. In particular, regarding electronic components, communication devices and imaging devices may be sensitive to noise interference, which may lead to performance degradation as the length of the wire increases.

### SUMMARY

The present disclosure describes a home appliance that shortens the wire installation path between a main body and a door while also insulating the wire from heat or cold air of the home appliance transmitted to the wire.

The present disclosure further describes arranging the wire along a certain installation path inside the home appliance.

The present disclosure further describes minimizing wire exposure by arranging the wire slightly toward the rear, away from the front of the home appliance.

According to one aspect of the subject matter described in this application, an appliance can include: a casing having a storage space therein; a door disposed at a front of the storage space and configured to open and close at least a portion of the storage space; a first electronic component disposed outside the casing; a second electronic component disposed at the door; a wire configured to electrically connect the first electronic component to the second electronic component; and a wire guide disposed between the casing and the wire and configured to block physical contact between a surface of the casing and the wire.

Implementations according to this aspect can include one or more of the following features. For example, the appliance can further include an equipment room defined outside the casing. The first electronic component can be disposed in the equipment room. The wire guide can be positioned between a first point at an entrance to an interior of the equipment room and a second point at an entrance to the door.

In some implementations, the wire guide can be disposed on a side surface of the casing and spaced apart from the side surface of the casing.

In some implementations, the wire guide can be disposed in a height direction of the casing. The wire can be disposed in the height direction of the casing along the wire guide.

In some implementations, the appliance can further include a cover plate surrounding the casing. The wire guide can be disposed between the casing and the cover plate, and the wire can be disposed between the wire guide and the cover plate.

In some implementations, the cover plate can include a side cover that surrounds a side surface of the casing. The wire guide can be disposed between the side cover and the casing. The side cover and the wire guide can define a guide path therebetween. The wire can be disposed along the guide path.

In some implementations, the wire guide can be disposed closer to the surface of the cover plate than to the surface of the casing.

In some implementations, a first end of the wire guide can be disposed at a lower position relative to the equipment room, and a second end of the wire guide can be disposed at a higher position relative to a bottom end of the door.

In some implementations, the second electronic component can be disposed inside the door. One end of the wire can enter the door from a lower portion of the door.

In some implementations, a mounting frame can be disposed at an edge of the equipment room. The wire can pass through the mounting frame and connect to the equipment room. The wire guide can be coupled to the mounting frame.

In some implementations, the wire guide can include an insulating body that has a plate-shape and a fixing body disposed at the insulating body and coupled to the casing or a frame part that surrounds the casing. The insulating body can include a spacing part that protrudes toward the casing or the wire.

In some implementations, the appliance can further include a front frame that is disposed at the casing and surrounds an edge of an entrance to the storage space. The wire guide can be fixed to the front frame.

In some implementations, the wire guide can be disposed closer to a front end of the casing than to a rear end of the casing.

In some implementations, the wire guide can include a binding member that surrounds and secures the wire.

In some implementations, a surface of the wire guide and a side surface of the casing can be spaced apart from each other to thereby define a space that accommodates an insulating material between the surface of the wire guide and the side surface of the casing.

In some implementations, the wire guide can include a fastening piece that protrudes toward the casing. The fastening piece can be inserted into a fastening groove that is defined at the casing.

In some implementations, the wire guide can include a first wire guide and a second wire guide that is positioned at a different height from the first wire guide and defines a continuous guide path with the first wire guide. The wire can be positioned along the guide path.

In some implementations, the wire guide can include a first plate body that is spaced apart from a side surface of the casing, and a second plate body that is connected to the first plate body and extends toward the side surface of the casing.

In some implementations, the wire can include a main wire configured to be connected to the first electronic component, and a door wire configured to connect the main wire to the second electronic component. The main wire and the door wire can be configured to be connected at a lower portion of the door. The wire guide can be disposed between the main wire and the surface of the casing.

According to another aspect, an appliance can include: a casing having a storage space therein; a cover plate that covers the casing; a door disposed at a front of the storage space and configured to receive an electronic component; a wire having a first end that is connected to the electronic component and a second end that extends outside the door; and a wire guide disposed between the casing and the cover plate. A portion of the wire can be disposed between the wire guide and the cover plate.

### BRIEF DESCRIPTION OF THE DRAWINGS

FIG. 1 is a perspective view illustrating an example of a home appliance.

FIG. 2 is a perspective view illustrating an example of a state in which a side cover is separated.

FIG. 3 is a perspective view illustrating an example of a state in which a side cover and a wire guide are separated.

FIG. 4 illustrates a front view illustrating an example of a state in which a door is removed from the home appliance illustrated in FIG. 1.

FIG. 5 is a perspective view illustrating an example of a configuration of a door and a wire of an example of a home appliance.

FIG. 6 is an enlarged front view of part A of FIG. 4.

FIG. 7 is a side view illustrating an example of a state in which the side cover is removed from the home appliance illustrated in FIG. 1.

FIG. 8 is a side view illustrating an example of a state in which a first wire guide is mounted on a front frame of an example of a home appliance.

FIG. 9 is a perspective view illustrating an example of a state in which a fastening piece of a first wire guide is inserted into a fastening groove of a front frame of an example of a home appliance.

FIG. 10 is a perspective view illustrating an example of a state in which a side cover is removed from the home appliance illustrated in FIG. 1.

FIG. 11 is a perspective view illustrating a structure of an equipment room of an example of a home appliance.

FIG. 12 is a perspective view illustrating a structure of a wire guide of an example of a home appliance.

FIG. 13 is a perspective view illustrating an example of a state in which a second wire guide is mounted on a front frame of an example of a home appliance.

FIG. 14 is a perspective view illustrating an example of a home appliance.

FIG. 15 is a perspective view illustrating an example of a home appliance.

FIG. 16 is a perspective view illustrating an example of a home appliance.

FIG. 17 is a perspective view illustrating an example of a home appliance.

FIG. 18 is a perspective view illustrating an example of a home appliance.

FIG. 19 is a perspective view illustrating a structure of a wire guide of an example of a home appliance.

FIG. 20 is a perspective view illustrating a structure of a wire guide of an example of a home appliance.

FIG. 21 is a perspective view illustrating a structure of a wire guide of an example of a home appliance.

### DETAILED DESCRIPTION

Hereinafter, one or more implementations of the present disclosure will be described in detail with reference to the illustrative drawings. When adding reference numerals to components in each drawing, it should be noted that identical components are given the same reference numerals as much as possible even if they are shown in different drawings. Additionally, in describing implementations of the present disclosure, if detailed descriptions of related known configurations or functions are judged to impede understanding of the implementations of the present disclosure, the detailed descriptions will be omitted.

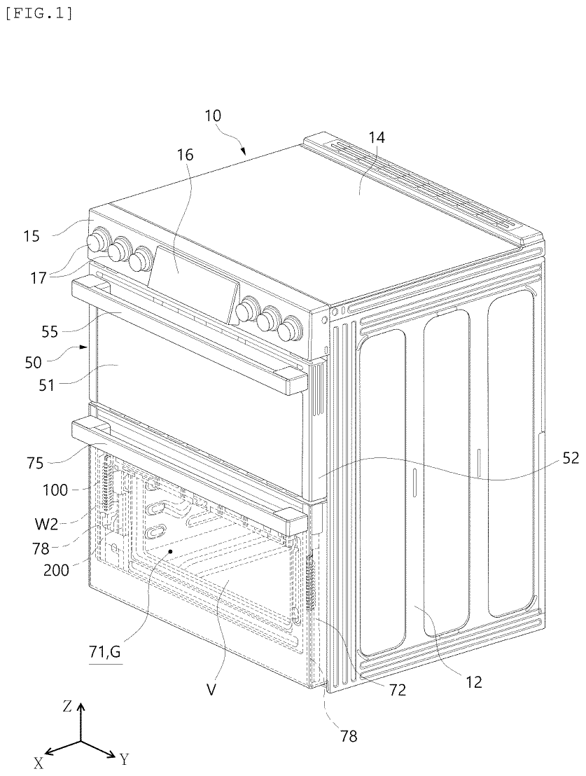

The present disclosure relates to a home appliance. Here, the home appliance can mean a device that has storage compartments 31 and 41 inside, and the storage compartments 31 and 41 are opened and closed by doors 50 and 70. The doors 50 and 70 are disposed in front of the storage compartments 31 and 41 and can serve to open and close the storage compartments 31 and 41. Here, “front” refers to the direction a user faces when the user is positioned in front of the home appliance. Referring to FIG. 1, the X-axis direction can be forward. The Y-axis direction can be the width direction of the home appliance. The Z-axis direction can be the height direction of the home description will be made based on this appliance. Below, direction.

The home appliance can include various home appliances such as cooking appliances, refrigerators, freezers, kimchi refrigerators, plant cultivation devices, stylers, and washing machines. Below, a cooking appliance among the home appliances will be described as an example.

In some examples, the door consists of two doors 50 and 70, but it can also be applied to a home appliance provided with only one lower door 70. The following is an example of the application of the two doors 50 and 70 to a cooking appliance. Also, among the two doors 50 and 70, the door placed relatively above is referred to the upper door 50, and the door placed below is referred to as the lower door 70.

In some implementations, a first electronic component 90 can be disposed in an equipment room (S1 in FIG. 11). A second electronic component 100 can be disposed on the lower door 70, which is one of the doors 50 and 70. The first electronic component 90 and the second electronic component 100 can be electrically connected to each other through wires W1 and W2. The first electronic component 90 can be a control part that controls the second electronic component 100. The first electronic component 90 can also control a display part 16 of the home appliance.

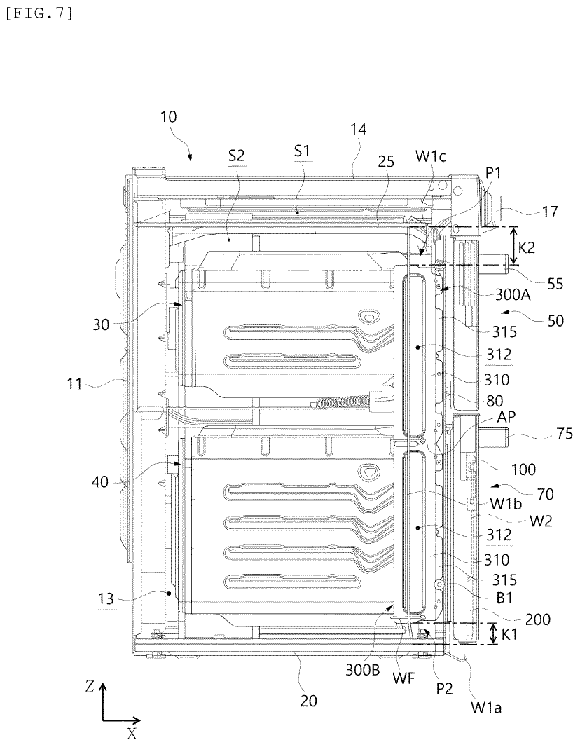

The second electronic component 100 can provide various functions to the lower door 70. For example, when the second electronic component 100 is an image acquisition module 100, an image sensing device 170 (see FIG. 7) can be provided in the image acquisition module 100 to acquire internal images of the storage compartment 31 and 41. A lighting device can be provided in the lower door 70 to increase illuminance of the storage compartments 31 and 41.

As another example, a display device can be disposed on the lower door 70 as the second electronic component 100. The display device can provide information on the home appliance to a user. The user can input an operation command through the display device.

A portion of the image acquisition module 100 or the display device can be disposed at the lower door 70. The second electronic component 100, such as the image acquisition module 100 or the display device, can exchange an electrical signal with the first electronic component 90 provided in the home appliance main body or can be connected to the main body through wires W1 and W2 for power supply. Hereinafter, the image acquisition module 100 will be described as an example of the second electronic component 100.

The second electronic component 100 can be disposed inside the lower door 70. The wires W1 and W2 connected to the second electronic component 100 can exit the lower door 70 and can be connected to the first electronic component 90. Among the total lengths of the wires W1 and W2, a section connected from the lower door 70 to the equipment room S1 can be disposed outside the side surfaces of casings 30 and 40 to be described below.

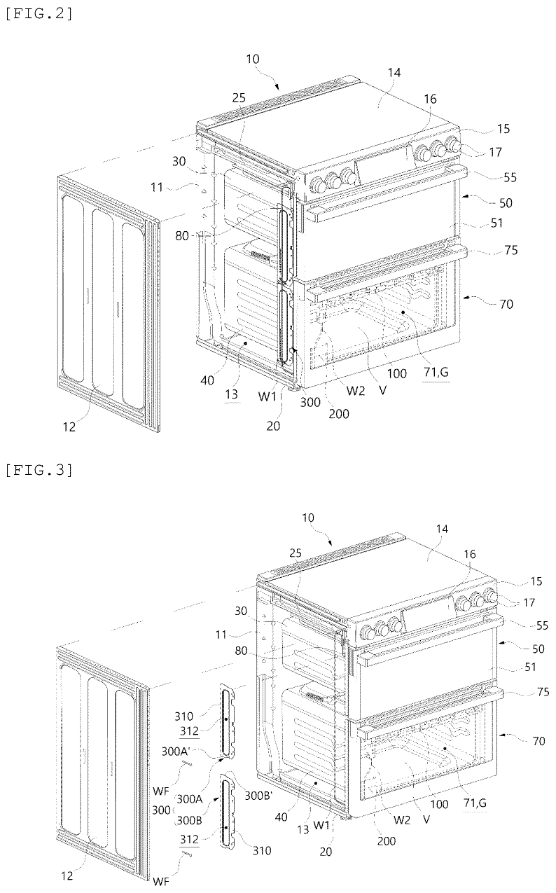

In some implementations, a portion of the wires W1 and W2 connected from the lower door 70 to the equipment room S1 can be disposed along a wire guide 300. In FIGS. 2 and 3, the wire guide 300 disposed on the side surfaces of the casings 30 and 40 is illustrated. In some examples, the wire guide 300 can include two wire guides 300A and 300B. The wire guide 300 will be described again below.

Referring to FIG. 1, a view of the cooking appliance to which the doors 50 and 70 are applied is illustrated. A main body 10 of the cooking appliance can have an approximately hexahedral shape. In some examples, the main body 10 of the cooking appliance can include two doors 50 and 70. The two doors 50 and 70 can be disposed to have different heights from each other. The two doors 50 and 70 can serve to shield the different storage compartments 31 and 41.

FIG. 2 illustrates a separated state of a side cover 12 constituting the main body 10 of the cooking appliance. When the side cover 12 is separated, an inner space 13 of the main body 10 of the cooking appliance can be exposed. Two casings 30 and 40 can be disposed in the inner space 13 at different heights from each other. Storage compartments 31 and 41 separated from each other can be provided in the two casings 30 and 40. As another example, only one casing can be provided or three or more casings can be disposed in the inner space 13. As another example, the two casings 30 and 40 can be disposed in the left and right directions. Reference numeral 11 illustrates a rear cover constituting the main body 10 of the cooking appliance.

An upper cover 14 can be provided in the main body 10 of the cooking appliance. The upper cover 14 can cover an upper portion of the inner space 13 so that the casings 30 and 40 are not exposed upward. The equipment room S1 can be disposed under the upper cover 14. The upper cover 14 can cover and shield the equipment room S1.

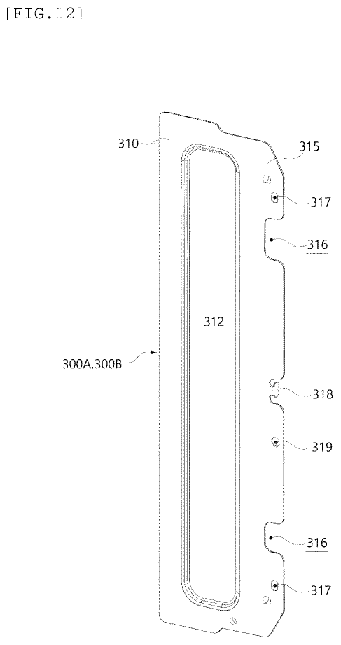

A lower frame 20 can be provided under the main body 10 opposite to the upper cover 14. The lower frame 20 can shield a lower portion of the inner space 13. Referring to FIG. 12, a wire pipe 23 can be provided in the lower frame 20 to guide a mounting direction of a main wire W1. The main wire W1 can be disposed on a lower side surface of the main body 10 along the wire pipe 23. In FIG. 12, reference numeral 22 represents a support leg for adjusting the height of the main body 10.

The rear cover 11, the side cover 12, the upper cover 14, and the lower frame 20 can constitute a cover plate. The cover plate can surround an outer periphery of the main body 10 except for a front surface of the main body 10.

An upper panel 15 can be provided on the upper portion of the cooking appliance. The upper panel 15 can be disposed on the front upper portion of the cooking appliance. The display part 16 can be provided on the upper panel 15. The display part 16 can serve to manipulate the function of the cooking appliance and display the state of the cooking appliance. The display part 16 can be configured as a display capable of performing a touch manipulation. The upper panel 15 can include a knob 17 performing a rotating operation or a pressing operation together with the display part 16. As another example, the display part 16 may not be provided in the upper panel 15, but the display part can be disposed at the lower door 70.

An equipment room S1 can be disposed behind the upper panel 15. The equipment room S1 can be a space partitioned from the inner space 13 and the casings 30 and 40. In some examples, the equipment room S1 is disposed below the upper cover 14. A first electronic component 90 connected to the display part 16 can be disposed in the equipment room S1.

A main wire W1 can be connected to the first electronic component 90. The main wire W1 can connect the first electronic component 90 including the display part 16 to a second electronic component 100. That is, the main wire W1 can connect the display part 16 and the second electronic component 100 of the lower door 70 such as an image acquisition module 100. The main wire W1 can be connected to a door wire W2 through a connector module 200 to be described below.

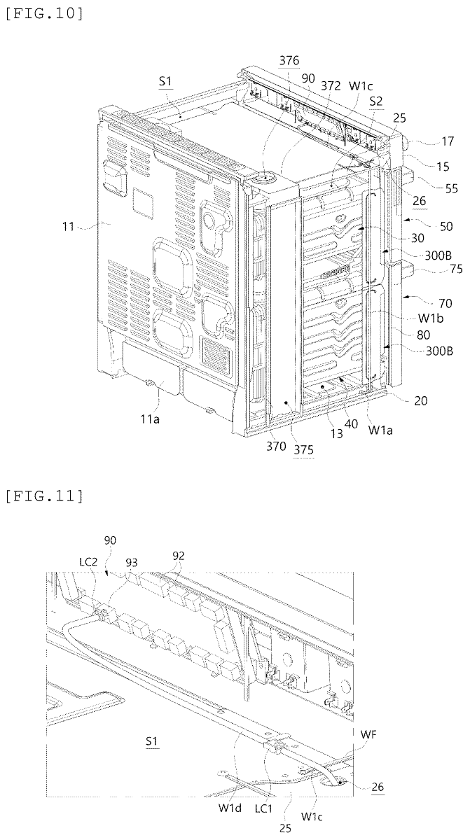

Referring to FIG. 2, a mounting frame 25 can be provided on an upper side of the main body 10. The mounting frame 25 can be disposed above the first casing 30. The mounting frame 25 can be disposed to cross a front frame 80, to be described later, from the rear cover 11. The mounting frame 25 can constitute a part of the equipment room S1. Referring to FIG. 10, a cooling duct 370, to be described below, can be fixed to the mounting frame 25.

As shown in FIGS. 10 and 11, a wire hole 26 can be opened in the mounting frame 25. The wire hole 26 can be formed to penetrate the mounting frame 25. The main wire W1 can pass through the wire hole 26 and enter the machine chamber S1. In some examples, the main wire W1 can pass through the wire hole 26 and exit the equipment room S1. The wire hole 26 can be provided at a position closer to the doors 50 and 70 than the rear cover 11 in the mounting frame 25.

The two casings 30 and 40 can be divided into a first casing 30 and a second casing 40. The first casing 30 and the second casing 40 can be placed in the inner space 13 at different heights. An upper storage compartment 31 can be provided inside the first casing 30. A lower storage compartment 41 can be provided inside the second casing 40. In this case, the upper storage compartment 31 and the lower storage compartment 41 are separated from each other, and only the front of each can be opened.

An upper door 50 can be placed in front of the first casing 30. A lower door 70 can be disposed in front of the second casing 40. In some examples, the upper door 50 and the lower door 70 can each be operated in a kind of pull-down method in which the upper end rotates up and down around the lower end. As another example, the upper door 50 and the lower door 70 can each be operated in a side swing manner.

Looking at the upper door 50, the front 51 of the upper door 50 can have a structure that allows the upper storage compartment 31 to be seen through. For example, the front 51 of the upper door 50 has a panel structure made of glass, so that the user can observe the inside of the upper storage compartment 31 through the upper door 50. As another example, the front 51 of the upper door 50 can be made of a dark material or coated with a separate film so that the upper storage compartment 31 may not be visible from the outside. Reference numeral 55 denotes a first handle for opening and closing the upper door 50.

The lower door 70 can be placed below the upper door 50. The lower door 70 can be placed in front of the second casing 40. The lower storage compartment 41 can be seen through the front of the lower door 70. The user can observe the inside of the lower storage compartment 41 through the front of the lower door 70.

In some implementations, a viewing part V (see FIG. 2) can be provided at the lower door 70. The viewing part V is for seeing the lower storage compartment 41 from the outside, and can be made of a transparent material. The viewing part V can be seen as a part of a front panel Ga forming the front surface of the lower door 70. The viewing part V can be provided at a central portion of the front panel Ga. For example, the edge portion of the front panel Ga can have a material having a high surface roughness, unlike the viewing part V. Alternatively, a separate opaque film can be applied to the edge portion of the front panel Ga. In this case, the edge portion of the front panel Ga except the viewing part V may not see through the lower storage compartment 41.

As another example, the edge of the front panel Ga corresponding to the outside of the viewing part V can be covered by a door frame 72. Here, the outside of the viewing part V can mean an edge of the front panel Ga disposed around the edge of the viewing part V.

As another example, the lower door 70 can be made of a dark material or coated with a separate film so that the lower storage compartment 41 may not be seen from the outside. As another example, a door panel G (see FIG. 2) can be omitted from the lower door 70, and an opaque metal or non-metal plate can constitute the front surface of the lower door 70. Even in this case, the lower storage compartment 41 may not be seen from the outside.

Referring to FIG. 2, a state in which the image acquisition module 100 and the connector module 200 are mounted inside the lower door 70 is illustrated. Although FIG. 2 illustrates positions where the image acquisition module 100 and the connector module 200 are mounted inside the lower door 70, the image acquisition module 100 and the connector module 200 may not be visible from the front of the cooking appliance. This is because, as described above, the edge portion of the front panel Ga is opaque except for the viewing part V. Reference numeral 75 denotes a second handle for opening and closing the lower door 70.

As another example, the image acquisition module 100 can be disposed at the upper door 50. As another example, two image acquisition modules 100 can be disposed at the upper door 50 and the lower door 70, respectively. As another example, the image acquisition module 100 and the connector module 200 can be divided into the upper door 50 and the lower door 70.

As another example, the image acquisition module 100 can be disposed outside the lower door 70 rather than inside the lower door 70. For example, the image acquisition module 100 can be disposed on the upper surface, the bottom surface, the front surface, the rear surface, the side surface, or the second handle 75 of the lower door 70.

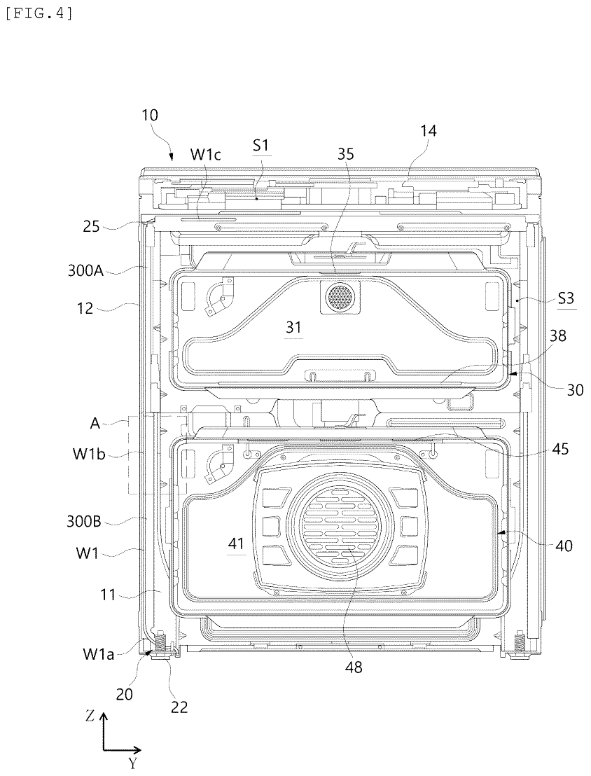

Looking at FIG. 4, a plurality of heating devices 35, 38, 45, 48 can be disposed behind the cooking appliance and inside the casings 30, 40. The heating devices 35, 38, 45, and 48 can heat the upper storage compartment 31 and the lower storage compartment 41. Among the heating devices 35, 38, 45, and 48, the first heating device 35 and the second heating device 38 can heat the upper storage compartment 31, respectively. Among the heating devices 35, 38, 45, and 48, the third heating device 45 and the fourth heating device 48 can heat the lower storage compartment 41, respectively. The fourth heating device can be a convection type heating device including a motor.

In this way, for example, the upper storage compartment 31 and the lower storage compartment 41 can be heated by the plurality of heating devices 35, 38, 45, and 48. Heat from the upper storage compartment 31 and the lower storage compartment 41 can be transmitted to the wires W1 and W2. In some implementations, the wire guide 300 is disposed between the casings 30 and 40 and the wires W1 and W2 to block heat in the casings 30 and 40 from being transferred to the wires W1 and W2. If this implementation is applied to an appliance that generates cold air, such as a freezer among home appliances, the wire guide 300 can block cold air from the casings 30 and 40 from being transferred to the wires W1 and W2.

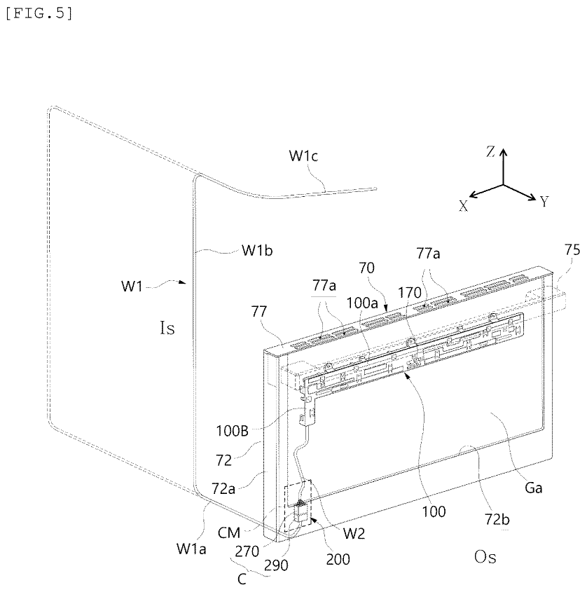

FIG. 5 shows the lower door 70 and the wires W1 and W2 viewed from the front of the lower door 70. For reference, the reference symbol Is denotes an inward direction toward the main body 10, and Os denotes outward direction away from the main body 10.

The wires W1 and W2 for power supply or signal transmission can be disposed inside the main body 10 of the home appliance and the lower door 70. These wires W1, W2 are a main wire W1 for connecting the connector module 200 of the lower door 70 and the first electronic component 90 inside the main body 10, and a door wire W2 for connecting between the connector module 200 and the image acquisition module 100. The structure of the wires W1 and W2 will be described again below.

If needed, a worker can separate the main wire W1 from the connector module 200 and maintain/repair the image acquisition module 100. For reference, although the image acquisition module 100 is shown in a transparent state in FIG. 5, the image acquisition module 100 can be shielded by an edge portion of the front panel Ga (see FIG. 5).

As shown in FIG. 5, a door connector 270 constituting the connector module 200 can be assembled with a mating connector 290. The door connector 270 can be connected to the door wire W2. The mating connector 290 can be connected to the main wire W1. When the two connectors 270 and 290 are coupled to each other, the main wire W1 and the door wire W2 can be electrically connected to each other. As another example, the two connectors 270 and 290 can be omitted, and the main wire W1 and the door wire W2 can be directly connected. As another example, the main wire W1 and the door wire W2 can be integrally formed.

The connector module 200 can be placed in a connector storage portion CM. The connector storage portion CM can be placed in an installation area provided inside the lower door 70. The connector storage portion CM can be viewed as an empty space that is part of the installation area. As another example, the connector storage portion CM can be integrally formed in the installation area, or can be a type of bracket formed separately.

As shown in FIG. 5, the connector storage portion CM can be disposed adjacent to a lower side of the lower door 70. When the connector storage portion CM is disposed at the lower side of the lower door 70, a worker can access the connector module 200 through the lower part of the lower door 70. If the connector storage portion CM is disposed at the lower end of the lower door 70, the connector module 200 may not be exposed to the outside. Additionally, since the entrance of the connector storage portion CM opens to the lower end of the lower door 70, the worker can easily access the connector module 200.

As another example, the connector storage portion CM can be disposed adjacent to the upper side of the lower door 70. Additionally, the entrance of the connector storage portion CM can be open to the side of the lower door 70.

The skeleton of the lower door 70 can be formed by a door frame 72. The door frame 72 can include a frame body 72a that has a rectangular frame shape. A penetrating portion 72b, which is a kind of empty space, can be opened at the center of the frame body 72a. The front panel Ga can be disposed in the penetrating portion 72b. Reference numeral 77a denotes a frame outlet 77a, which can be an outlet through which air passing through a cooling passage formed inside the lower door 70 is discharged to the outside.

As shown in FIG. 5, the second electronic component 100 can include a main unit 100A and a connection unit 100B. The main unit 100A can include an image sensing device 170. The connection unit 100B can create a path through which the door wire W2 is guided to the main unit 100A.

Looking at the wires W1, W2 with reference to FIG. 5, the wires W1, W2 can include the main wire connecting the first electronic component 90 of the lower door 70 and the mating connector 290 and the door wire W2 connecting between the door connector 270 and the second electronic component 100. The signal or power of the first electronic component 90 can be transmitted to the second electronic component 100 through the main wire W1—the mating connector 290—the door connector 270—the door wire W2. there is. Conversely, the signal of the second electronic component 100 can be provided to the first electronic component 90 through the door wire W2—the door connector 270—the mating connector 290—the main wire W1.

Referring to the structure of the main wire W1, the main wire W1 can include a connector connection part W1a connected to the mating connector 290, a component connection part W1c connected to the first electronic component 90, and a transmission part W1b connected between the connector connection part W1a and the component connection part W1c. In some examples, the connector connection part W1a, the component connection part W1c, and the transmission part W1b are configured integrally with each other, but are classified for convenience of explanation.

The connector connection part W1a can be disposed in the front-rear direction (X-axis direction). The connector connection part W1a can extend rearward from the mating connector 290 along the lower portion of the main body 10. The component connection part W1c can extend in the direction of the equipment room S1 from the upper end of the transmission part W1b, and in some examples, a part of the component connection part W1c can extend in the left-right direction (Y-axis direction).

The transmission part W1b can extend in the height direction (Z-axis direction) of the main body 10. The transmission part W1b can be disposed on the side surfaces of the casings 30 and 40. Since the transmission part W1b is disposed on the side surfaces of the casings 30 and 40, the entire length of the main wire W1 can be reduced as compared with that of the main wire W1 connected to the first electronic component 90 via the rear side of the main body 10. In FIG. 5, a dotted wire illustrates a path when the main wire W1 rotates on the rear surface of the main body 10 and enters the equipment room S1. Since the transmission part W1b is disposed closer to the front of the main body 10, that is, closer to the lower door 70, than to the rear of the main body 10, there is no need for the connector connection part W1a to extend to the rear of the main body 10. Accordingly, the entire length of the main wire W1 can be shortened, and noise mixed with signals can be reduced.

In some examples, since the transmission part W1b is disposed on the side surfaces of the casings 30 and 40, it can be more directly affected by heat diffused from the casings 30 and 40 as compared with the connector connection part W1a or the component connection part W1c. Therefore, the transmission part W1b can be blocked from the casings 30 and 40. Blocking between the transmission part W1b and the casings 30 and 40 can be performed by the wire guide 300.

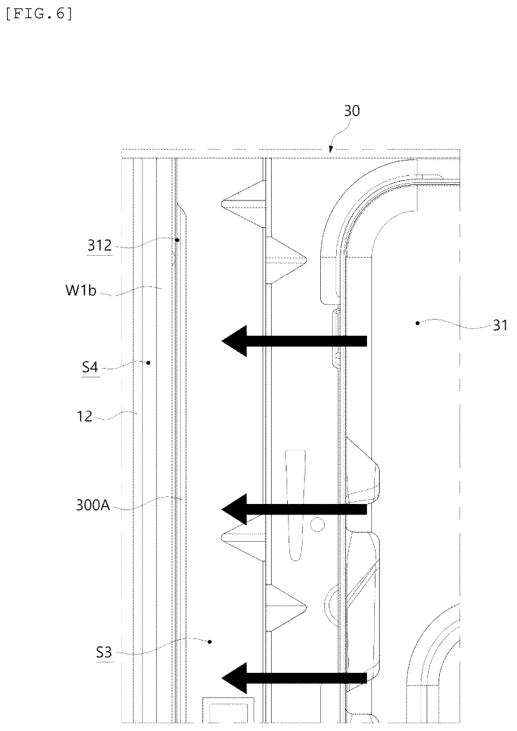

Referring to FIG. 6, in which part A of FIG. 4 is enlarged, an arrow indicates a direction in which heat of the upper storage compartment 31 is transferred. The heat of the upper storage compartment 31 is transferred outward, and a side insulation space S3 can be provided outside the first casing 30. The side insulation space S3 can be filled with an insulation material. The insulation material can block the flow of heat of the upper storage compartment 31 that is transferred to the outside. An upper insulation space S2 (see FIG. 7) partitioned from the equipment room S1 and connected to the side insulation space S3 can be provided under the equipment room S1.

The wire guide 300 can be disposed to be spaced apart from the side surfaces of the casings 30 and 40. The wire guide 300 can be disposed to face the side surfaces of the casings 30 and 40. The side insulation space S3 can be viewed as being formed in a portion of the wire guide 300 spaced apart from the side surfaces of the casings 30 and 40.

The wire guide 300 can be disposed outside the side insulation space S3. The wire guide 300 can laterally block a space between the casings 30 and 40 and the transmission part W1b of the main wire W1. The wire guide 300 can block the flow of heat transferred from the upper storage compartment 31 to the transmission part W1b of the main wire W1. Therefore, in some examples, the heat insulating material and the wire guide 300 can doubly block the flow of heat transferred to the transmission part W1b of the main wire W1.

Blocking laterally means that the casings 30 and 40 and the main wire W1 do not face each other directly. In this case, radiant heat generated from the surfaces of the casings 30 and 40 may not be directly transferred to the main wire W1.

As shown in FIG. 6, the wire guide 300 can be disposed between the casings 30 and 40 and the side cover 12. In this case, the wire guide 300 can be spaced apart from the surface of the side cover 12. A guide space S4 can be formed between the wire guide 300 and the side cover 12. The transmission part W1b of the main wire W1 can be disposed in the guide space S4 formed between the wire guide 300 and the side cover 12. Accordingly, the guide space S4 can form a guide path S4 blocked in both directions, and the influence of the temperature/humidity/vibration transmitted to the transmission part W1b of the main wire W1 can be reduced.

The wire guide 300 can be disposed closer to the surface of the side cover 12 than to the surfaces of the casings 30 and 40. Accordingly, the main wire W1 can also be disposed closer to the surface of the side cover 12 than to the surfaces of the casings 30 and 40, and the transmission part W1b of the main wire W1 can be less affected by heat transferred from the casing.

Referring to FIG. 7, a state in which the wire guide 300 is disposed on the side surfaces of the casings 30 and 40 is illustrated. The main wire W1 can be guided from a lower portion to an upper portion of the main body 10 along the wire guide 300. Both the wire guide 300 and the transmission part W1b of the main wire W1 can be disposed closer to the front surface than the rear surface of the main body 10.

The wire guide 300 can be disposed between a first point P1 entering the inside of the equipment room S1 and a second point P2 entering the doors 50 and 70. When the wire guide 300 is disposed between the first point P1 and the second point P2, both ends of the main wire W1 can be guided to the lower door 70 and the equipment room S1, respectively. Here, the second point P2 refers to a portion between a lower portion of the lower door 70 and a lower portion close to a bottom of the main body 10. The first point P1 refers to an upper portion of the main body 10 close to a mounting frame 25 to be described below.

The wire guide 300 can be disposed between the first point P1 and the second point P2 along a straight wire path. In some examples, the first point P1 and the second point P2 are spaced apart from each other in the height direction (Z-axis direction) of the main body 10. Accordingly, the wire guide 300 can be provided in the height direction of the main body 10. The main wire W1 can also be disposed along a straight wire path between the first point P1 and the second point P2 along the wire guide 300. The straight wire path can be the shortest distance connecting the first point P1 and the second point P2.

As shown in FIG. 7, one end of the wire guide 300 can be disposed at a position higher than the lower end of the lower door 70. It can be viewed that the second point P2 is located between one end of the wire guide 300 and the bottom surface of the equipment room S1. One end of the wire guide 300 and the lower frame 20 can be spaced apart by a predetermined distance K1.

The other end of the wire guide 300 can be disposed at a position lower than the equipment room S1. It can be viewed that the first point P1 is located between the other end of the wire guide 300 and the bottom surface of the equipment room S1. The other end of the wire guide 300 and the bottom surface of the equipment room S1 can be spaced apart by a predetermined distance K2.

In this way, when both ends of the wire guide 300 are spaced apart from the bottom of the main body 10 and the bottom of the equipment room S1, respectively, a section in which the wire guide 300 is omitted can be formed therebetween. In the section in which the wire guide 300 is omitted, the main wire W1 can be bent to form an entry path to the lower door 70 and the equipment room S1.

The wire guide 300 can be connected to a front frame 80. The front frame 80 can constitute the front surface of the casings 30 and 40 in which the doors 50 and 70 are disposed. The front frame 80 can be provided around the front inlet of the casings 30 and 40. The front frame 80 can extend outward from the front inlet of the casings 30 and 40. The front frame 80 can be viewed as a part of the casings 30 and 40 or a part of a frame part. The wire guide 300 can be connected to the side surface of the front frame 80.

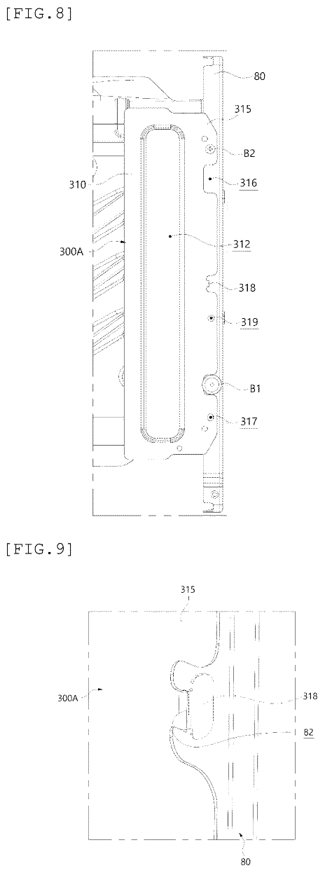

Referring to FIG. 7, a fixing body 315 of wire guides 300A and 300B can be disposed on the front frame 80. Referring to FIG. 8, the fixing body 315 can be fastened to the front frame 80 through a plate fastener B2. When the wire guides 300A and 300B are disposed on the side surfaces of the front frame 80, the remaining portions of the wire guides 300A and 300B except for the portions connected to the front frame 80 can be spaced apart from the side surfaces of the casings 30 and 40. The wire guides 300A and 300B can extend from the front frame 80 in the form of a kind of cantilever.

In some examples, the wire guide 300 can include a plurality of wire guides 300A and 300B. Referring to FIG. 7, a first wire guide 300A and a second wire guide 300B are provided to be disposed at a different height from each other. The second wire guide 300B can form a continuous guide path S4 (see FIG. 6) with the first wire guide 300A, and the wires W1 and W2 can be disposed along the guide path S4. The first wire guide 300A and the second wire guide 300B can have the same shape. As such, the plurality of wire guides 300A and 300B can also insulate the wires W1 and W2 provided in the home appliance having a high height.

The first wire guide 300A can be disposed adjacent to the first casing 30. The second wire guide 300B can be disposed adjacent to the second casing 40. Reference numeral AP indicates a portion where the first wire guide 300A and the second wire guide 300B contact each other. One end of the first wire guide 300A and the second wire guide 300B can be disposed in contact with each other. As another example, the first wire guide 300A and the second wire guide 300B can be arranged to be spaced apart from each other.

Referring to FIG. 9, a fastening groove 82 can be formed in the front frame 80. The fastening groove 82 can be formed by penetrating the front frame 80 in the left and right directions (Y-axis direction in FIG. 1). The first wire guide 300A can be provided with a fastening piece 318 protruding in the direction of the casing. The fastening piece 318 can be inserted into the fastening groove 82. When the fastening piece 318 is inserted into the fastening groove 82, the first wire guide 300A can be fixed to the front frame 80. In this state, when the plate fastener B2 passes through the fixing body 315, the wire guide 300 can be completely fixed to the front frame 80. As another example, the fastening piece 318 and the fastening groove 82 can be omitted. In another example, the plate fastener B2 can be omitted, and the first wire guide 300A can be fixed only with the fastening piece 318 and the fastening groove 82. As another example, the first wire guide 300A can be fixed to the front frame 80 by welding.

Looking at FIGS. 10 and 11, the equipment room S1 can be provided in an upper portion of the main body 10. The equipment room S1 can be disposed below the upper cover 14. The equipment room S1 can be formed in a place corresponding to below the upper cover 14 and behind the upper panel 15. As another example, the equipment room S1 can be disposed on the side, back, or bottom of the main body 10. In this case, the location of the first point P1 can also change.

The first electronic component 90 and a cooling fan can be placed in the equipment room S1. The cooling fan can serve to lower the temperature of the main body 10 by drawing in and circulating outside air. In FIG. 10, reference numeral 370 denotes a cooling duct 370 for guiding the flow of air drawn by the cooling fan. A cooling passage 375 can be formed in the cooling duct 370. Air flows through the cooling passage 375, thereby lowering the temperature of the equipment room S1. The cooling passage 375 can be covered by the side cover 12 to form a sealed air passage.

The first electronic component 90 can include a control part that controls the display part 16 and the second electronic component 100. Referring to FIG. 11, the first electronic component 90 can be composed of a substrate. A plurality of electrodes 92 can be disposed on the substrate. The display part 16 and the knob 17 can be disposed in front of the substrate.

Some electrodes 93 of the plurality of electrodes 92 can be connected to the main wire W1. The main wire W1 can be provided with an extension part W1d. The extension part W1d can be further extended from the component connection part W1c of the main wire W1. A first extension connector LC1 and a second extension connector LC2 can be provided at both ends of the extension part W1d, respectively. The first extension connector LC1 can be coupled to the component connection part W1c. The second extension connector LC2 can be coupled to the elements. As another example, the extension part W1d can be omitted, and the component connection part W1c can be directly coupled to the electrodes.

Referring to FIG. 12, the structure of the wire guides 300A and 300B is shown. The wire guides 300A, 300B can be made of a thin plate-shaped material. The wire guides 300A, 300B can have a structure where the height is greater than the width. Since the wire guides 300A, 300B are made of a plate-shaped structure, the thickness of the main body 10 of the home appliance can be prevented from increasing due to the wire guides 300A, 300B.

As another example, the wire guides 300A and 300B may not have a plate-shaped structure but can have a block structure with a predetermined thickness. As another example, the wire guides 300A and 300B can have a block structure with an empty space inside.

The wire guides 300A and 300B can include a plate-shaped insulating body 310. The insulating body can be spaced apart from the side of the casings 30 and 40 (refer to the Y-axis direction of FIG. 4). The insulating body 310 can serve to block between the main wire W1 and the casings 30 and 40. Also, the insulating body 310 can serve to guide the main wire W1.

A spacing part 312 can be provided in the insulating body 310. The spacing part 312 can protrude from the insulating body 310 toward the surfaces of the casings 30 and 40. The spacing part 312 can serve to reinforce the strength of the insulating body 310. The spacing part 312 can reduce the area in which the insulating body 310 is in contact with the main wire W1. As shown in FIG. 12, the spacing part 312 can have a structure recessed from the insulating body 310.

The insulating body 310 can be provided with a fixing body 315. The fixing body 315 can be provided at a portion extended from one side of the insulating body 310. The fixing body 315 can be viewed as a part of the insulating body 310. The fixing body 315 can be fixed to the front frame 80. The fixing body 315 can be provided with a plurality of fixing holes 317 and 319, and the plate fastener B2 (refer to FIG. 8) can be assembled to the fixing holes 317 and 319.

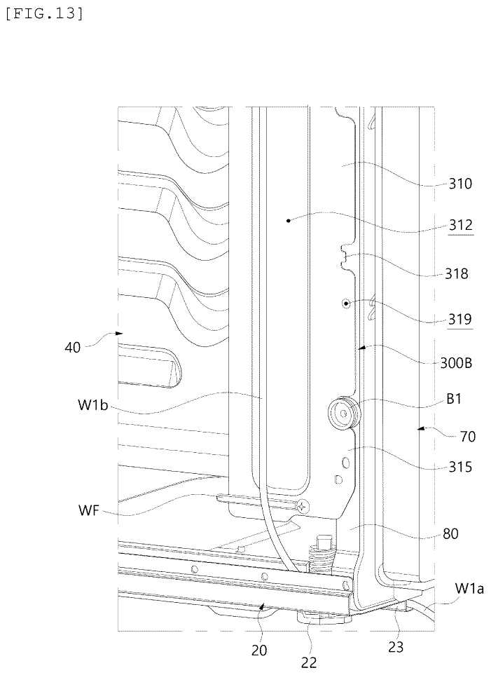

The fixing body 315 can be provided with a mounting groove 316. The mounting groove 316 can be formed by omitting a portion of the fixing body 315. As shown in FIG. 13, a cover fastener B1 can be disposed in the mounting groove 316. The cover fastener B1 can pass through the mounting groove 316 to be assembled with the front frame 80. A portion of the side cover 12 can be hung and fixed to the cover fastener B1.

The fixing body 315 can be provided with a fastening piece 318. The fastening piece 318 can be bent in a direction orthogonal to the fixing body 315. The fastening piece 318 can be inserted into the fastening groove 82 of the front frame 80. The fastening piece 318 can temporarily fix the wire guides 300A and 300B to the front frame 80 before the plate fastener B2 is assembled.

Referring to FIG. 13, the second wire guide 300B can be provided with a winding fastener WF configured to surround and fix the main wire W1. The winding fastener WF can surround the main wire W1 so that the main wire W1 does not deviate from the second wire guide 300B. A plurality of winding fasteners WF can be disposed along the longitudinal direction (height direction) of the second wire guide 300B.

In FIG. 13, a state before the winding fastener WF surrounds the main wire W1 is illustrated. One end of the winding fastener WF is fixed to the second wire guide 300B, and the other end of the winding fastener WF can be freely bent. When the other end of the winding fastener WF is bent to surround the main wire W1, the winding fastener WF can maintain the shape while surrounding the main wire W1. To this end, the winding fastener WF can be made of a metal material. As another example, the winding fastener WF can be a cable-tie or a general string structure.

As shown in FIG. 13, the fixing body 315 can be fixed to the front frame 80 to form a continuous side surface without being separated between the second wire guide 300B and the front frame 80. In this case, the main wire W1 can be prevented from escaping into the gap between the second wire guide 300B and the front frame 80 or from being damaged by the gap between the second wire guide 300B and the front frame 80.

Side surfaces of the wire guide 300 and the casings 30 and 40 can be spaced apart from each other. In FIG. 13, the side surface of the second casing 40 is exposed, but the insulating material can cover the side surface of the second casing 40. The insulating material can be filled between the second wire guide 300B and the second casing 40 spaced apart from each other. In this case, the second wire guide 300B can cover one end of the insulating material and can serve to press the insulating material.

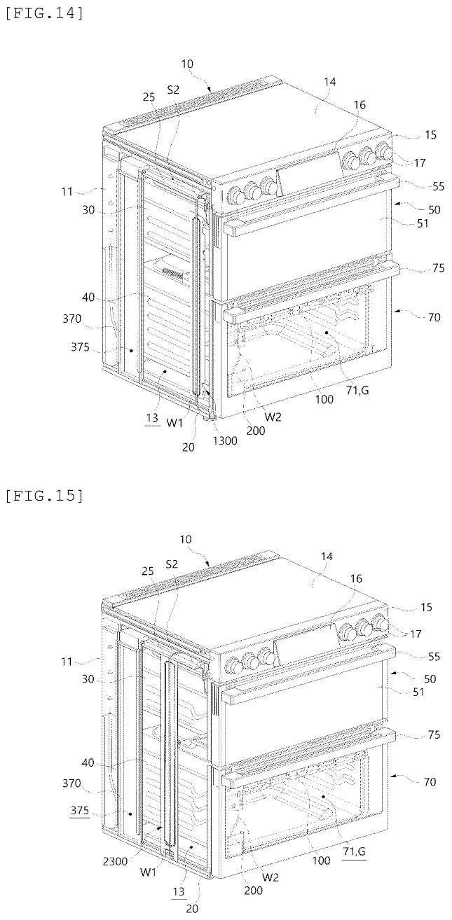

In FIG. 14, an implementation of the home appliance is illustrated. The wire guide 1300 can be composed of a single component. Unlike the previous implementation, the wire guide 1300 may not be composed of a plurality of wire guides 1300, but can be composed of only one wire guide 300. One wire guide 1300 can create a continuous guide path. The entire height of the wire guide 1300 can be lower than or equal to the height of the main body 10.

In FIG. 15, an implementation of the home appliance is illustrated. The wire guide 2300 can be disposed at a position retreating from the doors 50 and 70 toward the rear cover. Referring to FIG. 15, the wire guide 2300 can be disposed at a center portion of a side surface of the main body 10.

In this case, the wire guide 2300 is spaced apart from the front frame 80 and thus may not be fixed to the front frame 80. One end of the wire guide 2300 can be fixed to the mounting frame 25, not the front frame 80. The other end of the wire guide 2300 can be fixed to the lower frame 20. As another example, only one of both end portions of the wire guide 2300 can be fixed to the mounting frame 25 or the lower frame 20.

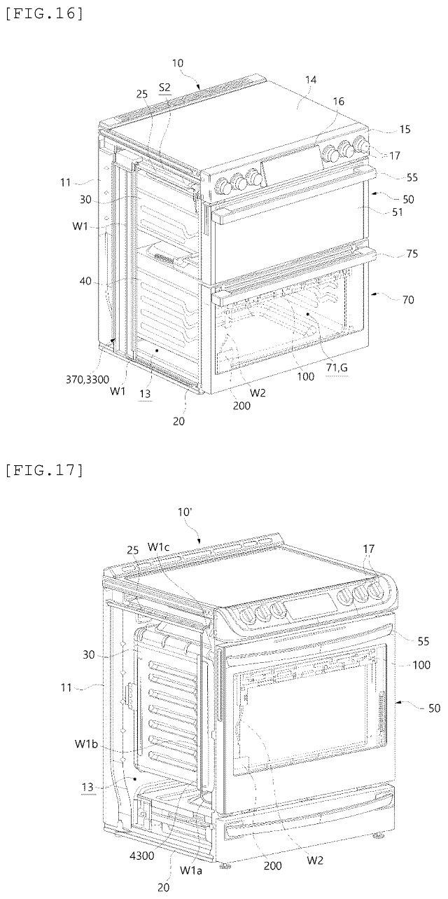

In FIG. 16, an implementation of the home appliance is illustrated. The main body 10 can be provided with a cooling duct 370 guiding the flow of air. The cooling duct 370 is for guiding the flow of air drawn by the cooling fan.

The cooling duct 370 can be provided in the height direction of the main body 10. The cooling duct 370 can be disposed in the height direction of the main body 10, and one end thereof can extend to the side surface of the equipment room S1. The cooling duct 370 can be the wire guide 3300. In other words, the cooling duct 370 can serve to cover the main wire W1 from the casings 30 and 40 along with the flow of air. In some implementations, the cooling duct 370 can be referred to as the wire guide 3300.

An implementation of the home appliance is illustrated in FIG. 17. The home appliance can be a single-stage cooking appliance. The cooking appliance of the single-stage structure has a relatively lower height compared to the previous implementation. The wire guide 300 can be configured as one. The lower end of the wire guide 4300 extends to the lower part of the casing, and the other end thereof extends to the equipment room S1.

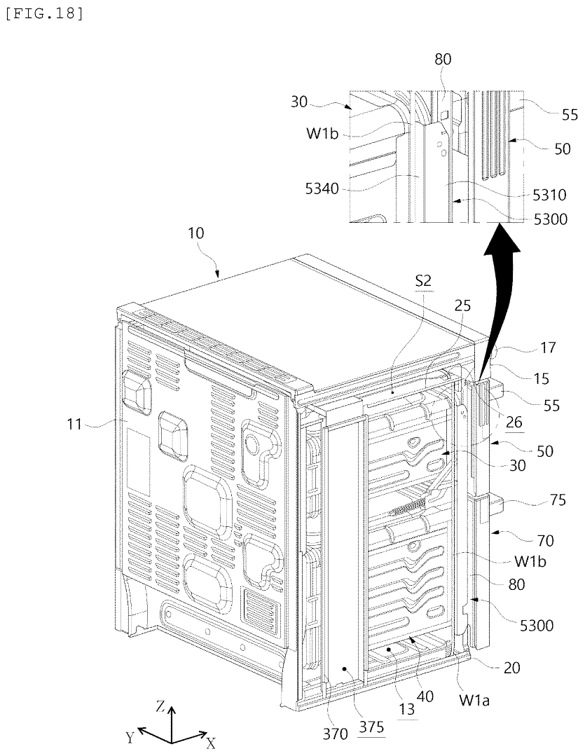

In FIG. 18, an implementation of the home appliance is illustrated. The wire guide 5300 can have an orthogonal cross-sectional structure. The wire guide 5300 can include a first plate body 5310 spaced apart from the side surfaces of the casings 30 and 40. The wire guide 5300 can include a second plate body 5340 connected to the first plate body 5310, and extending toward the side surfaces of the casings 30 and 40.

The first plate body 5310 and the second plate body 5340 can be connected to each other, but can be bent. The main wire W1 can be disposed along a surface of any one of the first plate body 5310 and the second plate body 5340. In FIG. 18, the main wire W1 is supported by the second plate body 5340, but unlike this, the main wire W1 can be supported by the first plate body 5310.

The second plate body 5340 can protrude toward the side surfaces of the casings 30 and 40, and can provide space between the first plate body 5310 and the side surfaces of the casings 30 and 40. The first plate body 5310 can be fixed to the front frame 80.

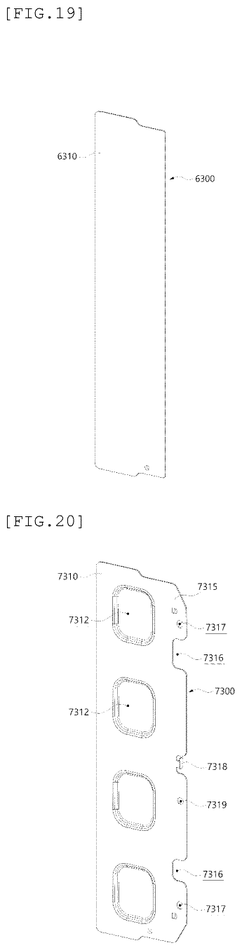

In FIG. 19 illustrates a structure of the wire guide 6300 constituting an implementation of the home appliance. As shown, the wire guide 6300 can have a plate body 6310 of a flat structure. Both surfaces of the wire guide 6300 can have a flat structure. The wire guide 6300 can be fixed by being welded or bonded to the front frame 80.

FIG. 20 illustrates a structure of the wire guide 7300 constituting an implementation of the home appliance. As shown, the wire guide 7300 can have a flat plate structure. The wire guide 7300 can include a plurality of spacing parts 7312. The plurality of spacing parts 7312 can protrude in lateral directions of the casings 30 and 40. Since the plurality of spacing parts 7312 do not contact the main wire W1, a contact area between the wire guide 7300 and the main wire W1 can be reduced. Additionally, the plurality of spacing parts 7312 can increase the strength of the wire guide 7300 and prevent the wire guide 7300 from being deformed due to high heat.

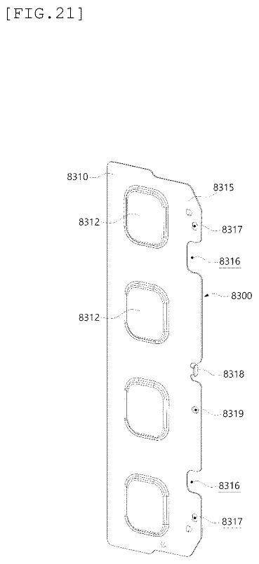

FIG. 21 illustrates a structure of the wire guide 8300 constituting an implementation of the home appliance. As shown, the wire guide 8300 can have a flat plate structure. The wire guide 8300 can be provided with a plurality of spacing parts 8312. The plurality of spacing parts 8312 can protrude toward the surface of the side cover 12. Since portions of the wire guide 8300 except for the plurality of spacing parts 8312 do not contact the main wire W1, a contact area between the wire guide 8300 and the main wire W1 can be reduced. Additionally, the plurality of spacing parts 8312 can increase the strength of the wire guide 7300 and prevent the wire guide 8300 from being deformed due to high heat.

The above description is merely an illustrative explanation of the technical idea of the present disclosure, and various modifications and variations will be possible to those skilled in the art without departing: from the essential characteristics of the present disclosure. Accordingly, the implementations disclosed in the present disclosure are not intended to limit the technical idea of the present disclosure but are for illustrative purposes, and the scope of the technical idea of the present disclosure is not limited by these examples. The scope of protection of the present disclosure should be interpreted in accordance with the claims below, and all technical ideas within the equivalent scope should be construed as being included in the scope of rights of the present disclosure.

What is claimed is:

1. An appliance comprising:
a casing having a storage space therein;
a door disposed at a front of the storage space and configured to open and close at least a portion of the storage space;
a first electronic component disposed outside the casing;
a second electronic component disposed at the door;
a wire configured to electrically connect the first electronic component to the second electronic component; and
a wire guide disposed between the casing and the wire and configured to block physical contact between a surface of the casing and the wire.

2. The appliance of claim 1, further comprising:
an equipment room defined outside the casing,
wherein the first electronic component is disposed in the equipment room, and
wherein the wire guide is positioned between a first point at an entrance to an interior of the equipment room and a second point at an entrance to the door.

3. The appliance of claim 1, wherein the wire guide is disposed on a side surface of the casing and spaced apart from the side surface of the casing.

4. The appliance of claim 1, wherein the wire guide is disposed in a height direction of the casing, and
wherein the wire is disposed in the height direction of the casing along the wire guide.

5. The appliance of claim 1, further comprising a cover plate surrounding the casing,
wherein the wire guide is disposed between the casing and the cover plate, and
wherein the wire is disposed between the wire guide and the cover plate.

6. The appliance of claim 5, wherein the cover plate comprises a side cover that surrounds a side surface of the casing,
wherein the wire guide is disposed between the side cover and the casing,
wherein the side cover and the wire guide define a guide path therebetween, and
wherein the wire is disposed along the guide path.

7. The appliance of claim 5, wherein the wire guide is disposed closer to the surface of the cover plate than to the surface of the casing.

8. The appliance of claim 1, further comprising:
an equipment room defined outside the casing,
wherein a first end of the wire guide is disposed at a lower position relative to the equipment room, and a second end of the wire guide is disposed at a higher position relative to a bottom end of the door.

9. The appliance of claim 1, wherein the second electronic component is disposed inside the door, and
wherein one end of the wire enters the door from a lower portion of the door.

10. The appliance of claim 1, further comprising:
an equipment room defined outside the casing,
wherein a mounting frame is disposed at an edge of the equipment room,
wherein the wire passes through the mounting frame and connects to the equipment room, and
wherein the wire guide is coupled to the mounting frame.

11. The appliance of claim 1, wherein the wire guide comprises:
an insulating body that has a plate-shape, and
a fixing body disposed at the insulating body and coupled to the casing or a frame part that surrounds the casing, and
wherein the insulating body comprises a spacing part that protrudes toward the casing or the wire.

12. The appliance of claim 1, further comprising:
a front frame that is disposed at the casing and surrounds an edge of an entrance to the storage space,
wherein the wire guide is fixed to the front frame.

13. The appliance of claim 1, wherein the wire guide is disposed closer to a front end of the casing than to a rear end of the casing.

14. The appliance of claim 1, wherein the wire guide comprises a binding member that surrounds and secures the wire.

15. The appliance of claim 1, wherein a surface of the wire guide and a side surface of the casing are spaced apart from each other to thereby define a space that accommodates an insulating material between the surface of the wire guide and the side surface of the casing.

16. The appliance of claim 1, wherein the wire guide comprises a fastening piece that protrudes toward the casing, and
wherein the fastening piece is inserted into a fastening groove that is defined at the casing.

17. The appliance of claim 1, wherein the wire guide comprises:
a first wire guide, and
a second wire guide that is positioned at a different height from the first wire guide and defines a continuous guide path with the first wire guide, and
wherein the wire is positioned along the guide path.

18. The appliance of claim 1, wherein the wire guide comprises:
a first plate body that is spaced apart from a side surface of the casing, and
a second plate body that is connected to the first plate body and extends toward the side surface of the casing.

19. The appliance of claim 1, wherein the wire comprises:
a main wire configured to be connected to the first electronic component, and
a door wire configured to connect the main wire to the second electronic component,
wherein the main wire and the door wire are configured to be connected at a lower portion of the door, and
wherein the wire guide is disposed between the main wire and the surface of the casing.

20. An appliance comprising:
a casing having a storage space therein;
a cover plate that covers the casing;
a door disposed at a front of the storage space and configured to receive an electronic component;
a wire having a first end that is connected to the electronic component and a second end that extends outside the door; and
a wire guide disposed between the casing and the cover plate,
wherein a portion of the wire is disposed between the wire guide and the cover plate.
